(19) United States
(12) Patent Application Publication
(10) Pub. No.: US 2003/0177858 A1
(43) Pub. Date: Sep. 25, 2003

(54) Religious steering wheel cover

(76) Inventor: Manny Lugo, El Paso, TX (US)

Correspondence Address: MANNY LUGO, 10370 Blythe Dr., El Paso, TX, 79924, US

(21) Appl. No.: 10/106,735

(22) Filed: Mar. 25, 2002

(51) Int. Cl. B62D 1/06

(52) U.S. Cl. 74/558

(57) ABSTRACT

There is provided a steering wheel cover that includes a leather, plastic or vinyl outer shell that is stretched or is laced in place on the steering wheel with the elements of a rosary on the top and a wire or conductive ribbon underneath connecting the metallic crucifix and beads or points of contact. Said metallic crucifix, beads or points of contact and wire or metallic ribbon must not touch any other metallic part of the steering wheel and must be connected together for maximum effect.

### BACKGROUND

1. Field of Invention

This invention is a steering wheel cover that facilitates the Catholic tradition of praying the Rosary.

2. Background Description of Prior Art

Consumers commonly purchase steering wheel covers for a decorative or insulation purposes. These are available in a wide variety of colors and materials.

The Catholic tradition of praying the Rosary dates back to before the fifth century A.D. Today Catholics and non-Catholics often hang a Rosary on their rear view mirror of their automobile. This causes an obstruction in the view path and may distract a driver with its motion. This also does not give the driver easy access to use it for prayer.

This invention combines the religious and safety needs of the consumer while providing the decorative and functional benefits of a steering wheel cover. It allows people to safely pray the Rosary while driving without having to remove one or both hands to change beads of the corresponding prayer. This religious steering wheel cover further allows safer praying of the Rosary in maintaining eyes on the road while driving.

An added feature of this invention is that it closes the circuit of the human body with electrical conductive materials such as wire or metallic ribbon and beads or points of contact, much like clasping the hands together while praying. Many people believe that this “human circuit” adds to the power of prayer.

Other benefits of this Religious steering wheel cover also include.

1. Better attitude while driving.

2. Reduced stress

3. Enhanced use of electrical field of body

4. Better use of commutes time or traffic delays.

5. Modernizes and adapts the Rosary to the present mode of travel

There are numerous steering wheel covers on the market. Some show added elements. U.S. Pat. No. 20020026850 to Albayrak (2002) shows a purely decorative element. U.S. Pat. No. 20010027689 to Fleckenstein (2001) has a decorative segment and detents, but again is purely decorative. U.S Pat. 20010010179 Ku. Describes varying colors and materials that can be used for visual appeal and decorative effect only Intensive research has not revealed a steering wheel cover with the purpose of facilitating prayer in the manner of this invention.

### SUMMARY

In accordance with described use, this invention is a steering wheel cover with a crucifix and Rosary type beads or contact points fixed onto the face of steering wheel cover, with a wire or metallic ribbon underneath that connects all beads or contact points in a visually appealing and functional prayer tool.

### DRAWINGS

Drawing Figures

In the drawings, closely related figures have the same number but different alphabetic suffixes.

FIG. 1 shows a view from the face of the wheel cover showing the placement of crucifix and beads or contact points.

FIG. 2 shows placement of ribbon or metallic ribbon connecting contact points and crucifix on the underneath side of the steering wheel cover.

FIG. 4 shows an additional embodiment: The Automated High Tech version.

### REFERENCE NUMERALS IN DRAWINGS

Part 20 Metallic crucifix

Part 22a Pater bead or point of contact slightly larger than Ave Beads or points of contact.

Part 24a, 24b and 24c Ave bead or point of contact slightly smaller than the Pater Beads or point of contact

Part 22b Pater bead or point of contact

Part 26a-26j Ave beads or points of contact

Part 22c Pater bead or contact point

Part 28a-28j Ave beads or points of contact

Part 22d Pater bead or point of contact

Part 30a-30j Ave beads or points of contact

Part 22e Pater bead

Part 32a-32j Ave beads or points of contact

Part 22f Pater bead

Part 34a-34j Ave bead or point of contact

Part 22g Pater bead

Part 36 Wire or electrical ribbon

Part 38 Lighted Liquid Crystal Display

Part 40 Pressure sensitive membrane for mode change

Part 42 Pressure sensitive membrane for speed and volume control

### DETAILED DESCRIPTION

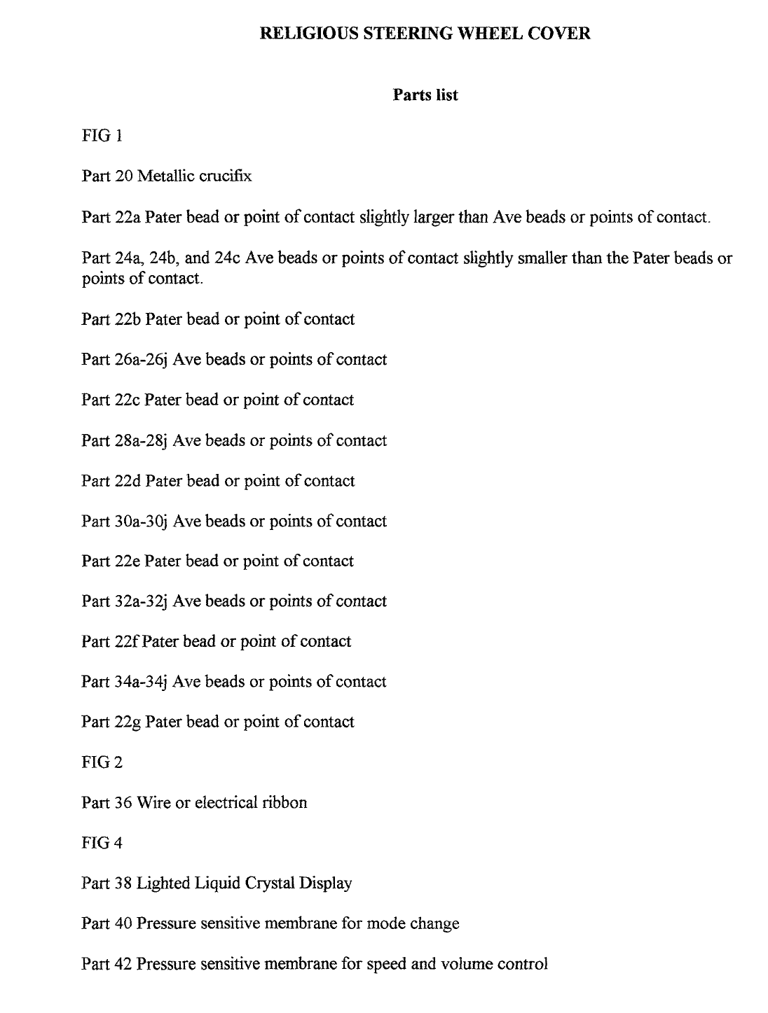

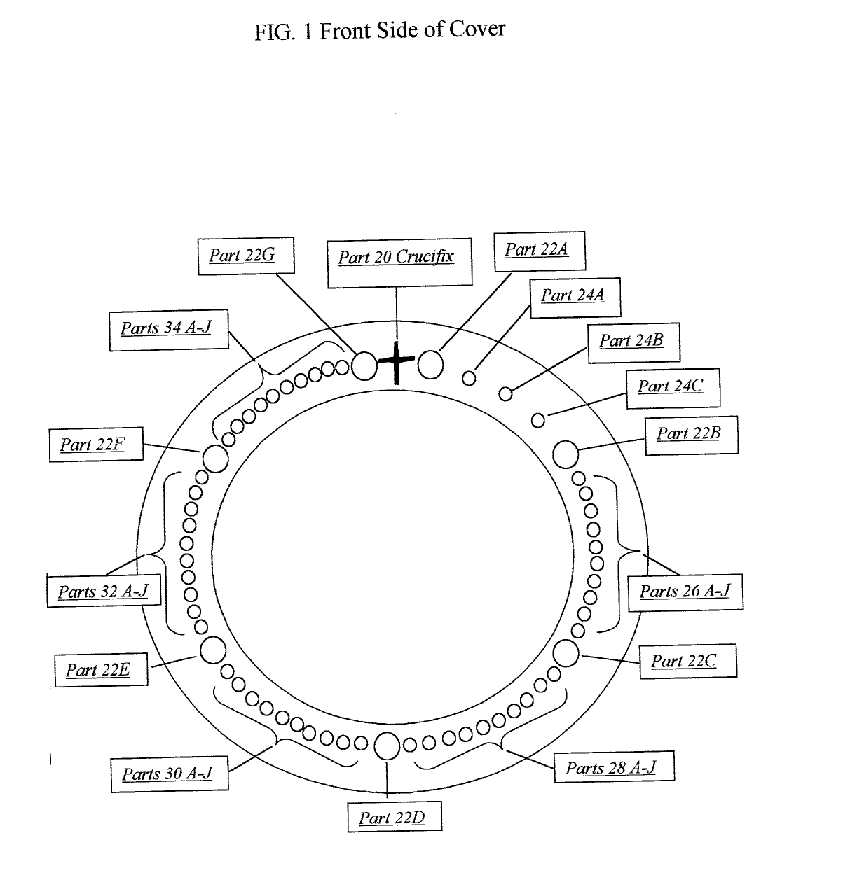

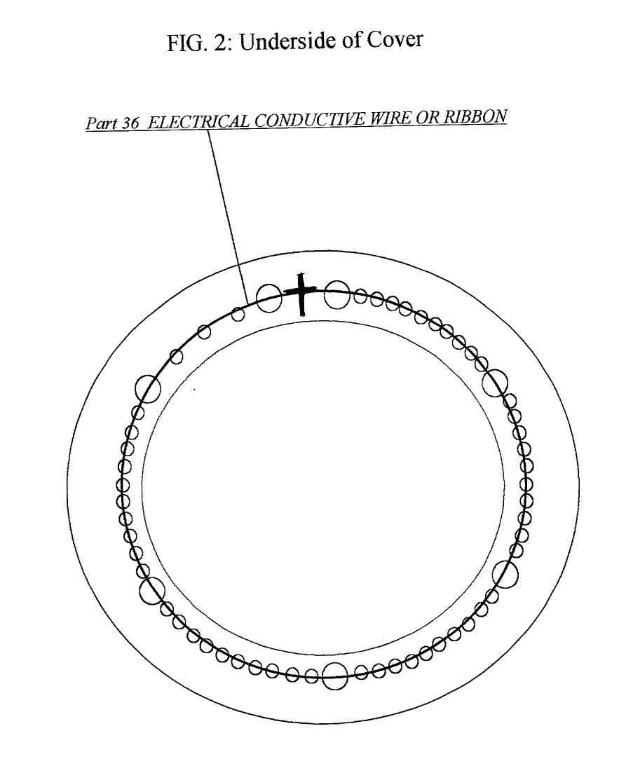

Description—FIGS. 1 and 2—Preferred Embodiment

A preferred embodiment of The Religious Steering Wheel Cover is illustrated in FIG. 1 top view and FIG. 2 view from bottom. On a steering wheel cover of leather or other similar material covering a spongy rubber base, a small metallic crucifix must be at the 12:00 position of the wheel. Then there is a space. Then one single bead or contact point. Then a space. Then three beads or contact points. Then a space. Then ten beads or contact points. Then a space. Then a single bead or contact point. Then a space. Then ten beads or contact points. Then a space. Then a single bead or contact point. Then a space. Then ten beads or contact points. Then a space. Then a single bead or contact point. Then a space. Then ten beads or contact points. Then a space. Then a single bead or contact point. Then ten beads or contact points. Then a space. Then a single bead or contact point that connects to the crucifix.

On the underside of the steering wheel cover a wire or metallic ribbon must connect all points of contact and the metallic crucifix by means of soldering or precise perforation and inserting beads or points of contact in to the metallic ribbon. Said crucifix, beads or contact points and wire or metallic ribbon must not come into contact with any other metallic part of the steering wheel.

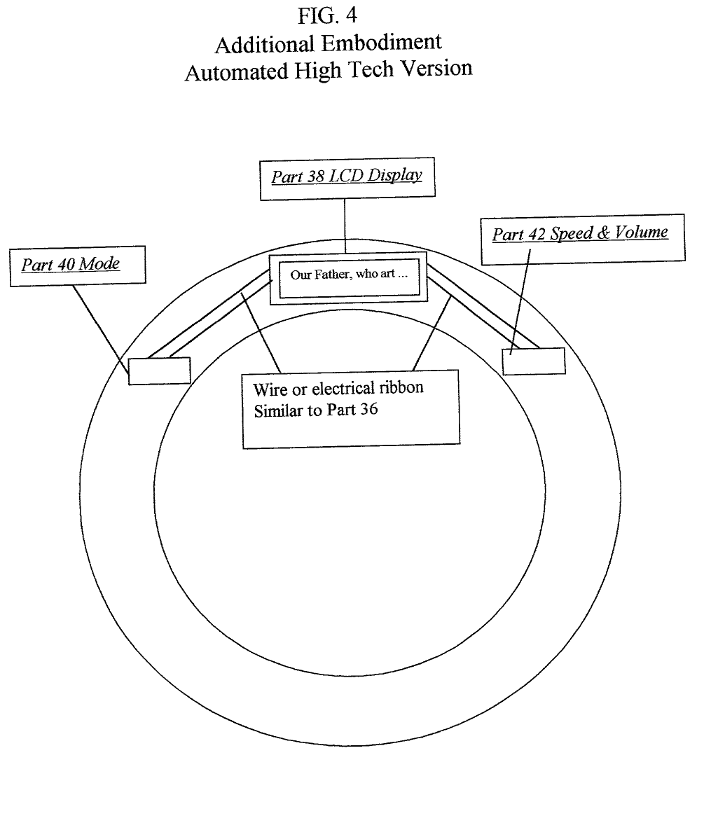

FIG. 4—Additional Embodiment

An additional embodiment is show in FIG. 4 that is an automated or high tech version. This embodiment entails two pressure sensitive membranes rectangular in shape placed at the 10:00 and 2:00 position of the wheel connected to each other and grounded to the L.C.D. display. Said membranes will allow the driver to be able to change mode, speed and sound in relation to programmed prayers of the Rosary. A light emitting diode or lighted liquid crystal display that will display the individual words to the prayers while an audible sound plays in accordance with the prayer at hand is another option of the automated high tech version of The Religious Steering Wheel Cover.

Advantages

From the description above, a number of advantages of my Religious Steering Wheel Cover become evident:

(a) Allows driver to pray Rosary while driving.

(b) Eliminates need for driver to remove one or both hands to pray Rosary while driving.

(c) Allows driver to keep eyes on the road while praying the Rosary.

(d) Removes obstacle from field of vision when Rosary is hung on automobile rear view mirror.

(e) Eliminates motion distraction caused by Rosary dangling on automobile rear view mirror.

(f) Provides a means to close the electrical circuit of the human body, believed my many to enhance the power of prayer.

Operation—FIG. 1

While keeping hands on wheel and eyes on road driver can place a finger or portion of hand on crucifix to pray an Apostle's Creed, then move hand or finger to the next bead or contact point to pray The Lord's Prayer. Movement to the next three beads or points of contact allow driver to pray three Hail Marys. The next bead or contact point allows driver to pray a Glory Be, one of the Sacred Mysteries then a Lord's Prayer. Then ten beads or contact points (also called a decade). Four more decades in the same order that are finished with a Hail Holy Queen.

Accordingly, the reader will see that the Religious Steering Wheel Cover will allow a driver to remove obstructions to view path, pray the Rosary while driving while eliminating the need for driver to remove one or both hands from the steering wheel to change beads or contact points and will allow driver to keep eyes on the road while enabling tactile change of beads or contact points. Further more the Religious Steering Wheel Cover will give the driver who uses it all the benefits of prayer using the Rosary.

Although the description above contains many specifics, these should not be construed as limiting the scope of the invention but as merely providing illustrations of some of the presently preferred embodiments of this invention. For examples, a larger steering wheel cover for 18 wheelers and expanded version for motorcycles, the beads or contact points can have other shapes and sizes such as hearts, roses or other customizable shapes. Thus the scope of the invention should be determined by the appended claims and their legal equivalents rather than by the examples given.

1. A vehicle steering wheel cover is made of leather, plastic or vinyl outer shell with a metallic crucifix and metallic beads and points of contact on the top of the wheel facing the driver, with a wire or metallic ribbon underneath connecting the crucifix and beads or points of contact enabling the driver to pray the Rosary while driving.

2. Said steering wheel cover will allow driver to pray the Rosary and keep both hands on the wheel while only moving a finger or repositioning a portion of the hand to the next corresponding prayer bead or point of contact.

3. Said steering wheel cover will enable driver to facilitate praying the Rosary with out having to remove Rosary from the automobile rear view mirror.

4. Said steering wheel cover will eliminate the need to remove one or both hands while changing from prayer bead or contact point to prayer bead or contact point.

5. Said steering wheel cover will “close” the electrical current or circuit of the human body in essentially the same manner as clasping hands, believed by many to enhance the power of prayer.

6. Said steering wheel cover will eliminate the obstruction from the mirror and eliminate the distraction of motion from the swaying Rosary.
